(19) United States
(12) Patent Application Publication
(10) Pub. No.: US 2014/0032157 A1
(43) Pub. Date: Jan. 30, 2014

(54) PROGRAMMED TRIGGERING OF DIAGNOSTICS FOR A SPACE CONDITIONING SYSTEM

(71) Applicant: Sunil K. Khiani, Plano, TX (US)

(72) Inventor: Sunil K. Khiani, Plano, TX (US)

(73) Assignee: Lennox Industries, Inc., Richardson, TX (US)

(21) Appl. No.: 13/556,342

(22) Filed: Jul. 24, 2012

(51) Int. Cl. G06F 19/00

(52) U.S. Cl. 702/122

(57) ABSTRACT

A method of performing method of performing a diagnostic testing procedure on a space-conditioning system, comprising running a triggering module. Running the triggering module includes reading a database of triggering rules in the triggering module of the space-conditioning system, checking the database to determine if any of the triggering rules are satisfied. Running the triggering module includes also includes setting an output state of the triggering module equal to true, if at least one of the triggering rules is satisfied, or, setting the output state of the triggering module equal to false, if none of the triggering rules are satisfied. Running the triggering module further includes communicating the output state to a diagnostic control module of the space-conditioning system.

### TECHNICAL FIELD

This application is directed, in general, to space conditioning systems, and, more specifically, to a programmed controller and method of performing equipment and system diagnostics, and module for triggering such diagnostics.

### BACKGROUND

Current space conditioning systems, such as heating, ventilation and air conditioning (HVAC) systems, often have built-in test diagnostics procedures that are initiated by a service technician. The technician typically manually triggers the test diagnostics on-site when the HVAC system has broken down, when system performance is not optimal, or when a periodic maintenance check has been scheduled by the end-user of the system.

### SUMMARY

One embodiment of the present disclosure is method of performing method of performing a diagnostic testing procedure on a space-conditioning system, comprising running a triggering module. Running the triggering module includes reading a database of triggering rules in the triggering module of the space-conditioning system, checking the database to determine if any of the triggering rules are satisfied. Running the triggering module includes also includes setting an output state of the triggering module equal to true, if at least one of the triggering rules is satisfied, or, setting the output state of the triggering module equal to false, if none of the triggering rules are satisfied. Running the triggering module further includes communicating the output state to a diagnostic control module of the space-conditioning system.

A system for performing a programmed execution of a diagnostics testing procedure on a space conditioning system space. The system comprises a triggering module configured to trigger the programmed execution of the diagnostics testing procedure. The triggering module includes a memory medium configured to store a database of triggering rules and a processing device configured to read and check the database of triggering rules to determine if any of the triggering rules are satisfied, and to set an output state of the triggering module equal to true, if at least one of the triggering rules is satisfied, or, setting the output state of the triggering module equal to false, if none of the triggering rules are satisfied. The triggering module includes also includes an output device configured to communicating the output state of the triggering module to a diagnostic control module.

### BRIEF DESCRIPTION

Reference is now made to the following descriptions taken in conjunction with the accompanying drawings, in which:

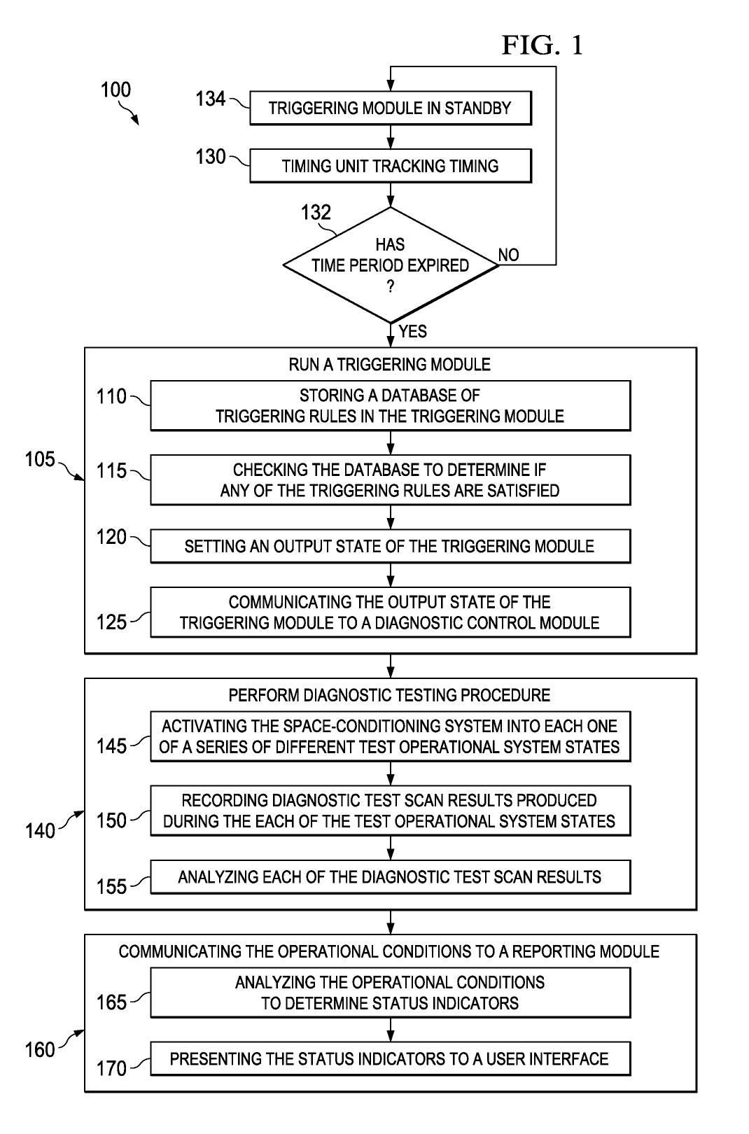

FIG. 1 presents a flow diagram of an example method of performing a diagnostic testing procedure on a space-conditioning system in accordance with the principles of the present disclosure;

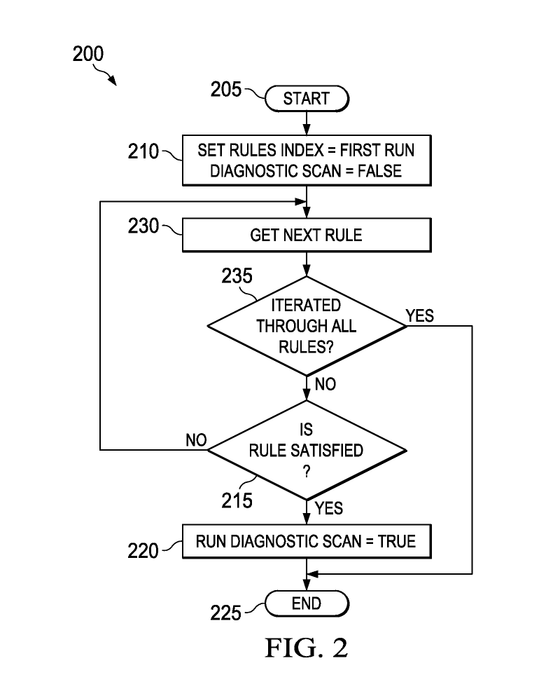

FIG. 2 presents a flow diagram of an example process for iteratively checking the database to determine if any of the triggering rules are satisfied, in accordance with the checking step described in the context of FIG. 1;

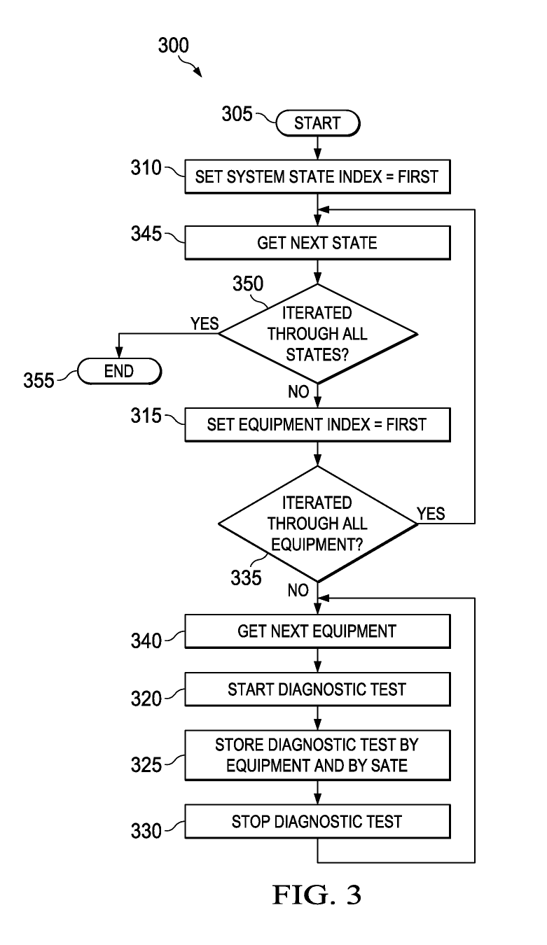

FIG. 3 presents a flow diagram of an example process for a diagnostic control module to conduct a diagnostic testing procedure of the space-conditioning system in accordance with the present disclosure;

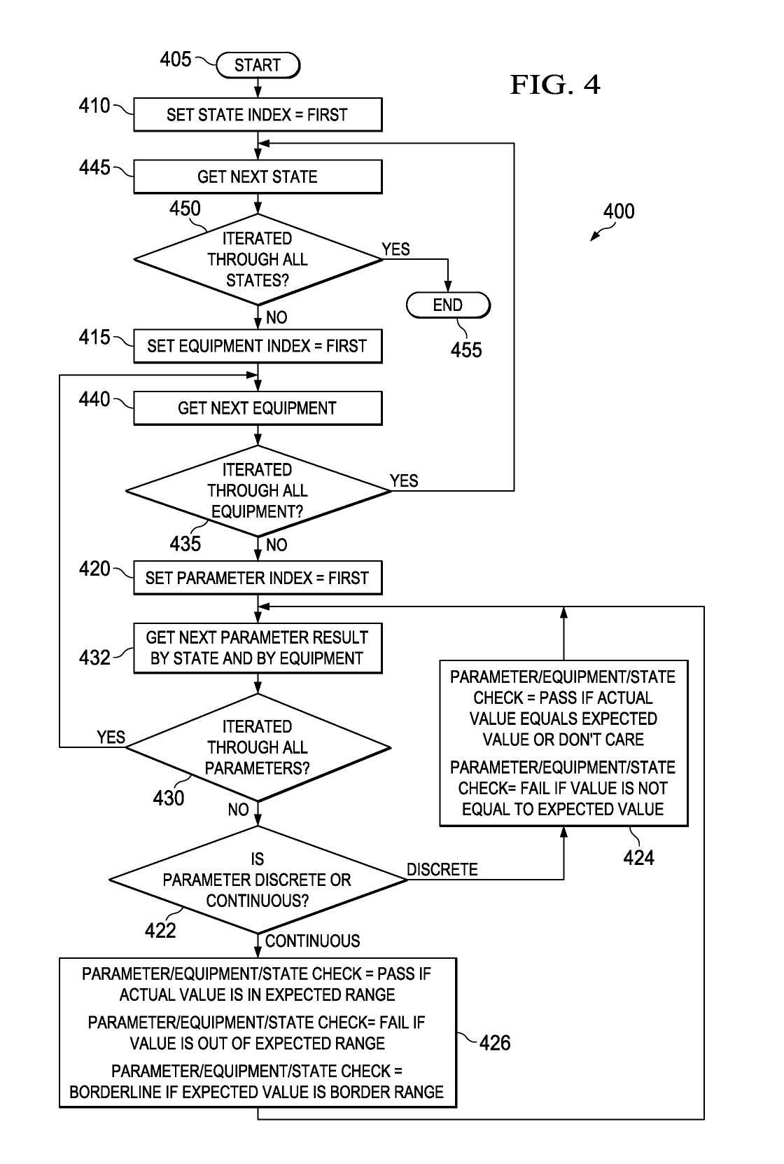

FIG. 4 presents a flow diagram of an example of process for analyzing the results of the diagnostic testing procedure, such as the test scan results of any of the procedures described in the context of FIG. 3;

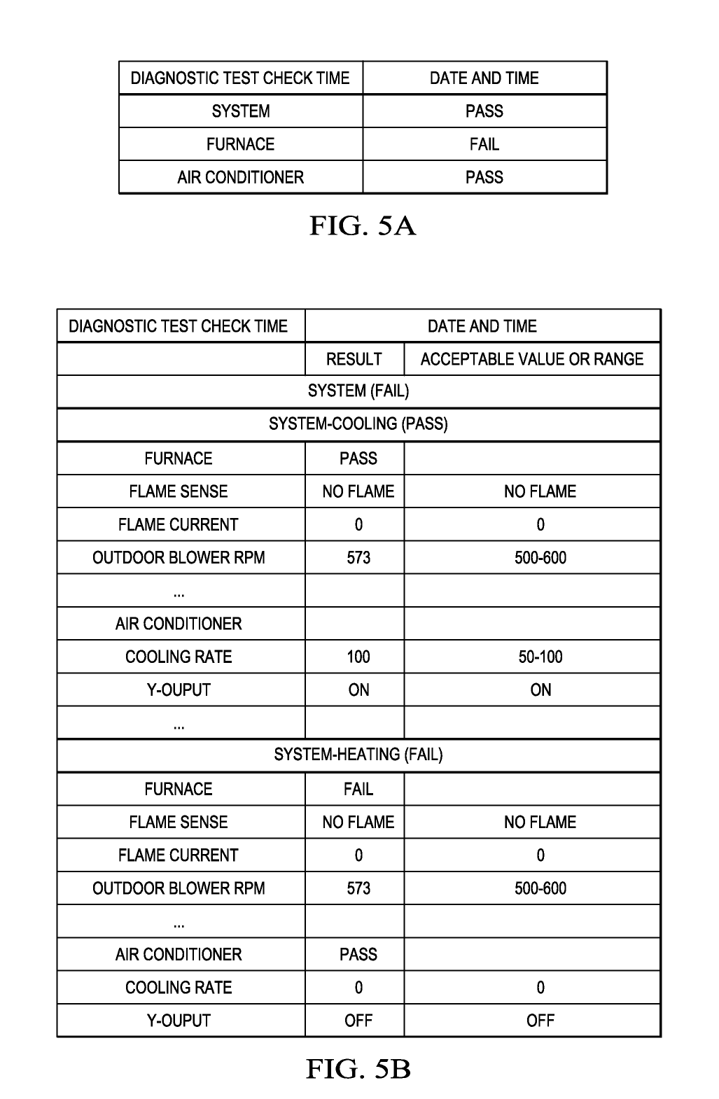

FIGS. 5A and 5B present example display outputs of status indicators to a user interface for an end-user and a service technician, respectively; and

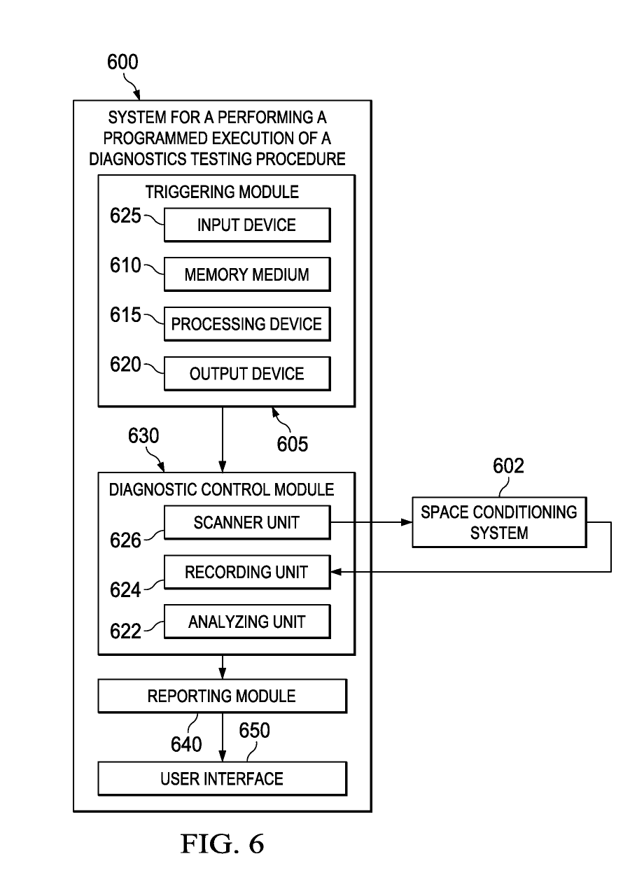

FIG. 6 presents a block diagram of an example system for performing a programmed execution of a diagnostics testing procedure of a space conditioning system, the system using any of the methods and processes discussed in the context of FIGS. 1-5B.

### DETAILED DESCRIPTION

The term, “or,” as used herein, refers to a non-exclusive or, unless otherwise indicated. Also, the various embodiments described herein are not necessarily mutually exclusive, as some embodiments can be combined with one or more other embodiments to form new embodiments.

As part of the present disclosure, it was recognized that the programmed execution of equipment and system diagnostics of an HVAC system, or, similar space-conditioning systems, provides a number of advantages over traditional approaches. Programmed equipment and system diagnostics can help end-users avoid system malfunctions or break-downs at time of greatest need (e.g., at the beginning of the summer or winter) by providing an early alert of problems. In some cases, an early alert of borderline acceptable performance of certain equipment can help the end-user avoid or reduce the time and cost of more expensive repairs if the equipment breaks down completely. Likewise, such early alerts can help service providers plan and distribute their work-load to times in the year other than when service calls are at their highest demand (e.g., at the beginning of the summer or winter). This, in turn, allows service providers to more quickly respond to the needs of their end-user customers.

FIG. 1 presents a flow diagram of an example method 100, such as a computer-executed method, of performing a diagnostic testing procedure on a space-conditioning system in accordance with the principles of the present disclosure. The method 100 comprises a step 105 of running a triggering module. Running the triggering module (step 105) includes a step 110 of storing a database of triggering rules in the triggering module, and a step 115 of checking the database to determine if any of the triggering rules are satisfied. Running the triggering module (step 105) further include a step 120 of setting an output state of the triggering module equal to true, if at least one of the triggering rules is satisfied, or, setting the output state of the triggering module equal to false, if none of the triggering rules are satisfied. Running the triggering module (step 105) further includes a step 125 of communicating the output state of the triggering module to a diagnostic control module, e.g., a diagnostic control module of the space-conditioning system.

As used herein, the terms true and false, include other equivalent Boolean choices (e.g., positive or negative; go or no go) that could provide a computer-readable indicator that any of the triggering rules in the database are satisfied or are not satisfied, respectively.

FIG. 2 presents a flow diagram of an example process 200 for iteratively checking the database to determine if any of the triggering rules are satisfied, in accordance with the checking step 115 described in the context of FIG. 1. As illustrated in FIG. 2, the triggering module enters step 115 at start step 205. In step 210 a rule index counter is set equal to FIRST and a diagnostic scan indicator is set equal to FALSE, to represent a default assumption that none of the triggering rules have been satisfied unless there is positive evidence to indicate otherwise. At step 215, it is decided whether or not the trigger rule (e.g., the first rule) under consideration has been satisfied or not. If the trigger rule under consideration has been satisfied then the process 200 changes, in step 220, the diagnostic scan indicator to equal TRUE and the process 200 is ended at step 225.

If the trigger rule under consideration has been not satisfied then the process 200 incrementally increases the rule index counter in step 230 (e.g., from FIRST to SECOND, SECOND to THIRD, etc . . . ), determines in step 235 whether or not all of the triggering rules have been checked. If it is determined, in step 235, that all of the triggering rules have been checked, then the process 200 is ended at step 225. If it is determined, in step 235, that not all of the triggering rules have been checked, then the process proceeds to step 215 as described above. If, after checking all of the triggering rules, none of the triggering rules have been satisfied, then the process ends at step 225 with the diagnostic scan indicator still set equal to FALSE.

An example of a database triggering rule includes a first rule that achieves the satisfied value if: the space-conditioning system has been in a quiescent state for N days continuously, the system currently in the quiescent state, and, a last diagnostic test was run N days ago, where N equals about 1 or more days.

Another example of a database triggering rule includes a second rule that achieves the satisfied value if: any equipment component of the space-conditioning system has been in a quiescent state for N days continuously, the system currently in the quiescent state, and, a last diagnostic test was run N days ago where N equals about 1 or more days.

Still another example of a database triggering rule includes a third rule that achieves the satisfied value if: any equipment component of the space-conditioning system has been in a quiescent state for N days continuously, the system currently is in the quiescent state, and, a last diagnostic test was run N days ago.

The term quiescent state, as used herein, means that none of components of the space condition system are presently actively performing their intended function. In some cases, it is advantageous to potentially trigger the diagnostic testing procedure during a quiescent state so that the environment of the conditioned space is minimally disrupted. Consider, for example the quiescent state occurring at the end of cooling cycle in the summer. If one of the triggering rule is satisfied and consequently, the diagnostic testing procedure is initiated so as to cause heating for diagnostics purposes, then environment is minimally disrupted because a cooling cycle. Consequently discomfort to the occupants of the conditioned space during the diagnostic testing procedure is minimized.

Yet another example of a database triggering rule includes a fourth rule that achieves the satisfied value if: a system component alert from the space condition system has been generated, the space conditioning system currently is in a quiescent state, and no diagnostic test has already been run after the occurrence of the system component alert. In some cases for example, as part of such a triggering rule, the space conditioning system could be configured to transmit any system component alerts that has been generated to the triggering module. Triggering the diagnostic testing procedure following a system component alert can advantageously more rapidly uncover other potential problems in the space condition system.

In some cases, the system component alert could have different levels severity (e.g., critical, moderate, minor) that can be raised by various components of the HVAC system (e.g., a furnace control board, an air conditioning control board, etc . . . ). A critical alert could issue for non-recoverable problems that requires the help of a service technician to resolve. Non-limiting examples of critical alerts include: furnace air circulation fan unable to start, a flame ignition circuit malfunction, analog-to-digital, electronic circuit or switch failures. A moderate alert could issue when there is an indication of possible product performance deterioration in the near future. Non-limiting examples of moderate alerts include: a primary limit switch opened, a low pressure switch opened in run, or in a trial run, for ignition. A minor alert could issue when there is a transient malfunction, or a malfunction, that does not affect the performance of the space conditioning system, sufficiently to require a service technician to resolve. Non-limiting examples of minor alerts include: a low pressure switch being stuck open, or the firing rate not reduced to match the air flow rate.

Running diagnostic testing procedure only after the last diagnostic test was run N days ago, where N equals about 1 or more days, such as set forth in example first, second, third or fourth triggering rules, advantageously avoids putting the space conditioning system through multiple diagnostic test, due, e.g., to the occurrence of multiple triggering rules being satisfied within a short period of time.

Yet another example of a database triggering rule includes a fifth rule that that achieves the satisfied value if: an automated diagnostic check has been set to occur every X days, the space conditioning system is in a quiescent state, and a last diagnostic test was run X days ago, where X equals about 1 or more days.

Another example database triggering rule includes a sixth rule that achieves the satisfied value if: an external signal has been sent to the triggering module to set the module's state to equal true. For example, the external signal can be a request from an end user of the space conditioning system input at a user interface within the conditioned space (e.g., a thermostat control panel), or from a remote location using mobile device (e.g., a smart phone), or from a computer connected to the internet via a wired or wireless communication network (e.g., as provided by telephone, cable company, or other internet or telephone service provider). For example, the external signal can be a service technician at a location remote from the conditioned space. For example, an end-user or a service technician could send the external signal setting the module's state to equal true, in anticipation of a schedule regular on-site maintenance visit by the service technician, thereby saving the service technician time while on-site by running the diagnostic check before the technician arrives.

Based on the present disclosure one or ordinary skill would understand that the above non-limiting listing of example triggering rules could be reduced to include only some of these rule, or that entirely rules could be additionally or alternatively stored in the database of triggering rules. For example one skilled in the art would understand how to add a seventh rule that achieves the satisfied value if: the system is powered down for Y days, thereby result in the diagnostics check being run upon the next powering up of the system. For example, one skilled in the art would appreciate that N, X or Y could be configurable time parameters that the end-user, or service technician, can define differently than presented in any of the example rule presented above or in other rules. For example based on the present disclosure one skilled in the

In some embodiments of the method 100, the triggering module is configured, to periodically run in accordance with step 105 after a time period (e.g., every day, week or month, or on specific dates of the calendar year, such as the first days of winter and summer) as defined by an end-user or a service technician of the space conditioning system. For example, as illustrated in FIG. 1, in some embodiments, a timing unit of the triggering module can be configured in step 130 track the progress of time and decide in step 132 whether or not the defined time period has expired or not. If it is decided in step 130 that the time period has not expired, then the triggering module is maintained in a standby state in step 134. If it is decided in step 130 that the time period has expired, then the timing subunit can cause the triggering module to run in accordance with step 105.

Based on the present disclosure, one of ordinary skill would appreciate that the timing unit could be part of other parts of the space conditional system other than the triggering module, and/or, be located remotely from either the triggering module or the space conditioning system. For instance, the timing unit can be part of the diagnostic control module of the space conditioning system. For instance, the timing unit can be embodied in a series of instructions of a computer program located on a server that is communication with the triggering module or other components of the space conditioning system.

In some embodiments of the method 100, the output state communicated in step 125 activates, in step 140, the diagnostic control module to perform the diagnostic testing procedure. For instance, when the output state of the triggering module is equal to true, then the diagnostic control module is activated, and the diagnostic testing procedure is performed in response to activation step 140.

In some embodiments of the method 100, performing the diagnostic testing procedure (step 140) includes a step 145 of sequentially activating the space-conditioning system into each one of a series of different test operational system states. The types and numbers of operational system states would depend upon the components present in the particular the space-condition system under consideration. For instance, the series of different test operational system states can include one or more of: a cooling state, a heating state, a humidifying state, a de-humidifying state, and cooling plus de-humidifying state, and a heating plus humidifying state. In order to minimize changes to the environment of the conditioned space, the test operational system states can be advantageously configured to continue only as long as necessary (e.g., one to two minutes or less, in some cases) to collect useful test scan results. In some cases, the trigger module can be programmed to perform the diagnostic testing procedure (step 140), e.g., at a certain time range during the day or on certain days, or only a subset of test operational system states and/or equipment states, again so as to minimize changing the environment of the conditioned space.

The diagnostic testing procedure can further include a step 150 of recording diagnostic test scan results produced during the each of the test operational system states. The diagnostic testing procedure can further include a step 155 of analyzing each of the diagnostic test scan results to determine whether the test operational system states are in an acceptable operational condition or unacceptable operational condition.

In some embodiments, for example, the diagnostic control module can include a scanner unit that puts the space-conditioning system into a test operational system state, a recording unit that records the result of the diagnostic test scan, and an analyzer unit that determines whether the test operational system states are in an acceptable operational condition or not.

In some cases, the acceptable operational condition is indicated by one of the diagnostic test scan result being one of: an acceptable discrete state for an equipment component of the space conditioning system (e.g., an electrical relay or pressure switch is on or off), an acceptable value for an operating parameter of an equipment component of the space conditioning system (e.g., an applied voltage to a equipment component is within an acceptable voltage range), or, a target performance indicator of the space conditioning system that is within an acceptable range (e.g., a target temperature, humidity, or temperature or humidity range), of air exiting a furnace component or air-conditioning component of the system to the conditioned space.

In contrast, an unacceptable operational condition could be indicated by the diagnostic test scan result not being in the acceptable discrete state, not being having an operating parameter value or target performance indicator that falls within an acceptable range. In some embodiments the process 300 can be conducted by the diagnostic control module and subunits (e.g., the scanner unit and the recording unit).

FIG. 3 presents a flow diagram of an example process 300 for a diagnostic control module to conduct a diagnostic testing procedure of the space-conditioning system in accordance with the present disclosure.

The diagnostic process 300 commences at start step 305, e.g., in response to activation step 140. In step 310 the diagnostic control module sets a system state index counter equal to FIRST, and in step 315, an equipment index counter is set equal to FIRST. Each count of the system state index counter corresponds to one of the various test operational system states such as discussed above (e.g., a cooling state, or heating state etc . . . ). Each count of the equipment index counter corresponds to one the various equipment components activated for the particular system state being tested (e.g., compressor, outdoor fan, indoor blower, of a air-conditioning unit, or the ignition unit, burner module, induction fan of a furnace unit). In step 320, the diagnostic test is commenced for the particular test operational system states and equipment component selected by the system state index counter and equipment index counter, respectively. In step 325 the diagnostic test scan results are recorded and stored in accordance with the system state index count and the equipment index count. In step 330 the diagnostic test is stopped. In step 335 it is determined whether or not all of the equipment components for the particular system state under consideration have been tested or not. If not all of the equipment in the equipment index count has been tested, then in step 340 the equipment index counter is incremented and steps 320, 325 330 are repeated. Decision step 335 and incrementing step 340 are repeated until all of the equipment components for the particular system state under consideration have been tested.

If in step 335 it is determined that all of the equipment components for the particular system state under consideration have been tested, then, in step 345 the system state index counter is incremented. The process 300 then determines in, step 350, whether or not the all of the system states have been tested or not. If, in step 350, it is determined that not all of the system state have been tested, then the process 300 repeats steps 315-330. If, in step 350, it is determined that all of the system state have been tested then the diagnostic process 300 ends at step 355.

In some embodiments of the method 100, steps 315-320 and steps 345-350 can be part of sequentially activating the space-conditioning system into each one of a series of different test operational system states in accordance with step 145. In some embodiments of the method 100 steps 325-330 can be part of recording the diagnostic test scan results in accordance with step 150.

FIG. 4 presents a flow diagram of an example of process 400 for analyzing the results of the diagnostic testing procedure, such as the test scan results of any of the procedures described in the context of FIG. 3. In some embodiments of the method 100, the analysis process 400 is part of the step 155 of analyzing each of the diagnostic test scan results as discussed in the context of FIG. 1. In some embodiments the process 400 can be conducted by the diagnostic control module subunits (e.g., the analyzer unit).

Analogous to the diagnostic process 300 described in FIG. 3, the analysis process 400 commences at start step 405, includes a step 410 of setting a system state index counter equal to FIRST, and step 415 or setting an equipment index counter equal to FIRST. In some example embodiments, start step 405 can be initiated at the end of the diagnostic process 300 at step 355 (FIG. 3), or, at the transitions from recording step 150 to analyzing step 155 (FIG. 1).

In step 420 a parameter index count is set equal to FIRST. The parameter index count corresponds to the parameter value result for each of the various diagnostic test scan results that were generated for each particular combination of test operational system states and equipment components assessed in the diagnostic process 300.

In decision step 422 it is determined whether or not the parameter under consideration is a discrete parameter (i.e., on/off, pass/fail or other Boolean choices, for either a system state or an equipment component state) or a continuous parameter (e.g., a voltage, temperature, humidity, etc . . . , for either a system state or an equipment component state).

If, in decision step 422 the parameter is determined to be a discrete parameter, then the process 400 conducts an discrete parameter value evaluation step 424, whereas if parameter is determined to be a continuous parameter then the process 400 conducts a continuous parameter value evaluation step 426.

In some example embodiments of the process 400, the discrete parameter value evaluation (step 424) can include setting a check result parameter value equal to pass, if the test scan result discrete value is equal to the expected value, or, fail, if the test scan result discrete parameter value is not equal to the expected value.

In some example embodiments of the process 400, the continuous parameter value evaluation (step 426) can include setting a check result parameter value equal to pass if the test scan result continuous parameter value is within an expected range of values, fail if the parameter value is outside of the expected range of values, or borderline, if the parameter value is close to a boundary value the defines the accepted range of values (e.g., within 10 percent of a maximum or minimum boundary value and still within the accepted range of values).

In step 430 it is determined whether or not all of the parameters for the particular equipment component and system state under consideration have been evaluated or not. If not all of the parameters has been evaluated, then in step 432 the parameter index count is incremented and steps 422, 424, 426, 430 are repeated. If in step 430 it is determined that all of the parameters have been evaluated, then the process 400 proceeds to step 435 to determine whether or not all of the equipment components for the particular system state under consideration have been tested or not. If not all of the equipment in the equipment index count has been tested, then in step 440 the equipment index counter is incremented and steps 420-430 repeated. Decision step 435 and incrementing step 440 are repeated until all of the equipment components and their parameter values for the particular system state under consideration have been tested.

If in step 435 it is determined that all of the parameters for the equipment components for the particular system state under consideration have been evaluated, then, in step 445 the system state index counter is incremented. The process 400 then determines in, step 450, whether or not the all of the system states have been evaluated or not. If, in step 450, it is determined that not all of the system state have been evaluated, then the process 400 repeats steps 415-440. If, in step 450, it is determined that all of the system states have been evaluated then the diagnostic process 400 ends at step 455.

As illustrated in FIG. 1, in some embodiments, the method 100 includes further including the step 160 of communicating the operational conditions (e.g., the parameter values discussed in the context of FIG. 4) to a reporting module, a step 165 of analyzing the operational conditions to determine status indicators for the space condition system by the reporting module, and a step 170 of presenting at least a portion of the status indicators to a user interface, by the reporting module.

In some cases the reporting module can be physically separated, and in some cases remotely located, from the diagnostic control module. In other cases, however, the reporting module can be a unit of the diagnostic control module.

In some cases, as part of analyzing the operational conditions to determine the status indicators in step 165, the reporting module can be configured to perform various logic evaluations to facilitate the analysis. In some cases, for instance, the logic evaluation for a equipment component includes: a) designing the equipment component status as passing all of the diagnostic testing procedures if all the parameters values associated with the equipment component have an acceptable value (e.g., a parameter value that is an acceptable discrete value or value within an acceptable range) for all of test operational system states. b) Designating the equipment component status as failing the diagnostic testing procedures if one or more parameter values has an unacceptable value (e.g., a parameter value outside of the acceptable range or not having the acceptable discrete value) for any test operational system states. c) Designating the equipment component as having a borderline passing status of the diagnostic testing procedures if one or more parameters values is near (e.g., within 10 percent) of a boundary value for a range of acceptable values and none of the parameter values an unacceptable value.

In some cases, for instance, the logic evaluation for an equipment component includes: d) Designating the system as passing the diagnostic testing procedures if all the parameter values for all of the equipment components are acceptable for all the test operational system states. e) Designating the system as failing the diagnostic testing procedures if nay the parameter values for any of the equipment components are unacceptable for any the test operational system states. f) Designating the system as borderline passing the diagnostic testing procedures if one or more parameters values is near (e.g., within 10 percent) of a boundary value for a range of acceptable values and none of the parameter values an unacceptable value for any of the equipment components for any of the test operational system states.

In some cases, as part of presenting the status indicators in step 170, the reporting module can be configured to present one set of status indicators in one report for an end-user and a different set of status indicators in another report for a service technician. FIGS. 5A and 5B present example display outputs of status indicators to a user interface for an end-user and a service technician, respectively.

In some cases, such as illustrated in FIG. 5A, the user interface includes a first display output, e.g., for an end-user of the system, first display output providing pass or fail indicators of the entire system, air-conditioning subunit (e.g., outdoor heat exchangers, heat pump etc . . . ) and furnace subunits (e.g., indoor furnace, air handler, electric heater etc . . . ) of the system. In some cases, for instance, the user interface includes a second (or alternative) display output, e.g., for a service technician of the system, the second display output providing a listing of each of the diagnostic test scan results, and an acceptable discrete indicator, or, acceptable range for each of the diagnostic test scan results.

In some case, for instance, for a report to a service technician, the portion of the status indicator communicated to the reporting module includes a listing of each of the diagnostic test scan results, and an acceptable discrete indicator, or, acceptable range indicator for each of the diagnostic test scan results. In some cases, for instance, the portion of the analysis of the diagnostic test scan results communicated to the reporting module includes an indication of the acceptable condition having borderline acceptable status. In some case, for instance, the second display output is communicated to the service technician located in a location that is remote from the system via an electronic communication module. For example, the reporting module can store present and previous reports locally (e.g., in a component of the space conditioning system) or alternatively or addition remotely, e.g., on a computer or computer server connected to the reporting module via an electronic communication module (e.g., telephone, internet or other wired or wireless communication means). For instance, the reporting module can email the appropriate reports to the end user report and service technician via internet.

Another embodiment of the disclosure is a system for a performing a programmed execution of a diagnostics testing procedure on a space conditioning system. FIG. 6 presents a block diagram of an example of such a system 600, the system 600 configured to use any of the methods and processes discussed in the context of FIGS. 1-5B, as part of performing the programmed execution of the diagnostics testing procedure on a space conditioning system 602.

One skilled in the art would understand how various modules of the system 600 could be embodied as separate electronic devices or a single electronic device, e.g., a circuit board integrated into one or more control boards or thermostats of the space conditioning system, or, as computer programs on a computer in communication with one or more control boards of the space conditioning system.

With continuing reference to FIGS. 1-5B, FIG. 6 illustrates that the system 600 comprises a triggering module 605 configured to trigger the programmed execution of the diagnostics testing procedure, e.g., in accordance with the method 100. The triggering module 605 includes a memory medium 610 (e.g., a computer program embodied in memory media such a hard disk, RAM, ROM or other computer-readable media familiar to those skilled in the art) configured to store a database of triggering rules. The triggering module 605 also comprising a processing device 615 (e.g., computer IC circuitry such, logic circuits, protocol data unit comparator or similar devices familiar to those skilled in the art) configured to read and check, e.g., in accordance with steps 110 and 115, respectively, the database of triggering rules to determine if any of the triggering rules are met, and to set, e.g., in accordance with step 120, an output state of the triggering module equal to true, if at least one of the triggering rules is satisfied, or, setting the output state of the triggering module equal to false, if none of the triggering rules are satisfied. The triggering module 605 also comprising an output device 620 (e.g., communication bus, electronic transmitter or similar devices familiar to those skilled in the art) configured to communicate. e.g., in accordance with step 125 the output state of the triggering module to a diagnostic control module.

In some cases the triggering module further includes an input device 625 (e.g., input devices such as a keyboard, mouse, touch screen connected to an electronic receiver of the module 605). The input device 625 can be configured to receive updated triggering rules, e.g., from an end-user or service technician of the space conditioning system 602, or, from the manufacturer of the space conditioning system 602 and/or the system 600 performing the programmed execution of the diagnostics testing procedure. For instance, the input device 625 can facilitate updates to existing triggering rules or new triggering rules provided by the manufacturer of the space conditioning system or maintenance or service provider of the system, based on the new equipment components present in the system and/or new operational parameters of the equipment components. For instance, in some cases, the input device 625 can be configured to add, delete, update, enable, or disable any of the triggering rules, to thereby provide runtime and build time configurability. For example runtime configurability could allow triggering rules to be enabled or disabled during system operation. For example build time configurability could allow the manufacturer to customize triggering rules so that the end-user has certain choices provided through software updates.

Some embodiments of the system 600 may comprise only the triggering module 605. For instance, when the output state of the triggering module is equal to true, the triggered diagnostics testing procedure can subsequently be initiated manually, e.g., by an on-site service technician or end-user. Other embodiments of the system 600, however, can further include other modules to facilitate conducting the triggered diagnostics testing procedure and reporting the results of the procedure.

For instance, the system 600 can include the diagnostic control module 630 which is configured to perform the diagnostic testing procedure. The diagnostic control module 630 can be configured to carry out the appropriate method 100 steps presented in FIG. 1, including the example process 300 for a diagnostic testing procedure such as presented in FIG. 3 or the example analysis process 400 presented in FIG. 4. For instance, the diagnostic control module 630 can be configured to perform one or more of the diagnostic testing procedure step 140. For example the sequentially activation step 145 can be carried out via a scanner unit 632 of the module 630. A recording unit 634 can record diagnostic test scan results in accordance with step 150. An analyzing unit 636 can analyze the diagnostic test scan results in accordance with the step 155.

For instance, the system 600 can include reporting module 640 configured to carry out the appropriate method 100 steps presented in FIG. 1. For instance, the reporting module 640 can be configured to receive operational conditions results from the diagnostic control module, e.g., as part of step 160. The reporting module 640 can be configured to determine, as part of step 165, status indicators for the space condition system based on an analysis of the receive operational conditions results. The reporting module 640 can be configured to, as part of step 170, present at least a portion of the status indicators to a user interface 650, e.g., to an end-user and a service technician such as discussed in the context of FIGS. 5A and 5B, respectively.

Those skilled in the art to which this application relates will appreciate that other and further additions, deletions, substitutions and modifications may be made to the described embodiments.

What is claimed is:

1. A method of performing a diagnostic testing procedure on a space-conditioning system, comprising:
running a triggering module, including:
a) reading a database of triggering rules in the triggering module;
b) checking the database to determine if any of the triggering rules are satisfied;
c) setting an output state of the triggering module equal to true, if at least one of the triggering rules is satisfied, or, setting the output state of the triggering module equal to false, if none of the triggering rules are satisfied; and
d) communicating the output state to a diagnostic control module of the space-conditioning system.

2. The method of claim 1, wherein the database of triggering rules includes a first rule that achieves the satisfied value if: the space-conditioning system has been in a quiescent state for N days continuously, the system currently in the quiescent state, and, a last diagnostic test was run N days ago, where N equals about 1 or more days.

3. The method of claim 1, wherein the database of triggering rules includes a second rule that achieves the satisfied value if: any equipment component of the space-conditioning system has been in a quiescent state for N days continuously, the system currently in the quiescent state, and, a last diagnostic test was run N days ago where N equals about 1 or more days.

4. The method of claim 1, wherein the database of triggering rules includes a third rule that achieves the satisfied value if: any equipment component of the space-conditioning system has been in a quiescent state for N days continuously, the system currently is in the quiescent state, and, a last diagnostic test was run N days ago.

5. The method of claim 1, wherein the database of triggering rules includes a fourth rule that achieves the satisfied value if: a system component alert from the space condition system has been generated, the space conditioning system currently is in a quiescent state, and no diagnostic test has already been run after the occurrence of the system component alert.

6. The method of claim 1, wherein the database of triggering rules includes a fifth rule that achieves the satisfied value if: an automated diagnostic testing procedure has been set to occur every X days, the space conditioning system is in a quiescent state, and a last diagnostic test was run X days ago, where X equals about 1 or more days.

7. The method of claim 1, wherein the database of triggering rules includes a sixth rule that achieves the satisfied value if: a external signal has been sent to the triggering module to set the module's state to equal true.

8. The method of claim 1, wherein the triggering module is configured to periodically run after a time period as defined by an end-user or a service technician of the space conditioning system.

9. The method of claim 1, wherein a timing subunit is configured to track time, to decide if the defined time period has expired or not expired, and to cause the triggering module to run if the defined time period has expired.

10. The method of claim 1, wherein the output state communicated in step (d) activates the diagnostic control module to perform the diagnostic testing procedure.

11. The method of claim 10, wherein the diagnostic testing procedure includes:
sequentially activating the space-conditioning system into each one of a series of different test operational system states;
recording diagnostic test scan results produced during the each of the test operational system states; and
analyzing each of the diagnostic test scan results to determine whether or not each of the test operational system states, and equipment components used in each of the test operational system states, are in an acceptable operational condition or an unacceptable operational condition.

12. The method of claim 11, wherein the acceptable operational condition is indicated by one of the diagnostic test scan result being one of: an acceptable discrete state for an equipment component of the space conditioning system, an acceptable value for an operating parameter of an equipment component of the space conditioning system, or, a target performance indicator of the space conditioning system that is within an acceptable range.

13. The method of claim 11, further including the steps of:
e) communicating the operational conditions to a reporting module of the space-conditioning system;
f) analyzing the operational conditions to determine status indicators for the space condition system;
g) presenting at least a portion of the status indicators to a user interface.

14. The method of claim 13, wherein the portion of the status indicator communicated to the reporting module includes a listing of each of the diagnostic test scan results, and an acceptable discrete indicator, or, acceptable range indicator for each of the diagnostic test scan results.

15. The method of claim 13, wherein the portion of the analysis of the diagnostic test scan results communicated to the reporting module includes an indication of the acceptable condition having a borderline acceptable value.

16. The method of claim 13, wherein the user interface includes: a first display output for an end-user of the system, first display output providing pass or fail indicators of the entire system, air-conditioning and furnace subunits of the system; and
a second display output for a service technician of the system, the second display output providing a listing of each of the diagnostic test scan results, and an acceptable discrete indicator, or, acceptable range for each of the diagnostic test scan results.

17. The method of claim 16, wherein the second display output is communicated to the service provide located in a location that is remote from the system via an electronic communication module.

18. A system for performing a programmed execution of a diagnostics testing procedure on a space conditioning system space, comprising:
a triggering module configured to trigger the programmed execution of the diagnostics testing procedure, including:
a memory medium configured to store a database of triggering rules;
a processing device configured to read and check the database of triggering rules to determine if any of the triggering rules are satisfied, and to set an output state of the triggering module equal to true, if at least one of the triggering rules is satisfied, or, setting the output state of the triggering module equal to false, if none of the triggering rules are satisfied; and
an output device configured to communicating the output state of the triggering module to a diagnostic control module.

19. The system of claim 18, wherein the triggering module further includes an input device configured to receive updates to the set of triggering rules.

20. The system of claim 18, further including:
the diagnostic control module configured to perform the diagnostic testing procedure; and
a reporting module configured to receive operational conditions results from the diagnostic control module, determine status indicators for the space condition system based on an analysis of the receive operational conditions results, and presenting at least a portion of the status indicators to a user interface.
